(19) United States
(12) Patent Application Publication
(10) Pub. No.: US 2022/0158843 A1
(43) Pub. Date: May 19, 2022

(54) DIAGNOSTIC OVER IP AUTHENTICATION

(71) Applicant: Ford Global Technologies, LLC, Dearborn, MI (US)

(72) Inventors: Humberto Eduardo Franyie Quintana, Westland, MI (US); Venkata Kishore Kajuluri, Southgate, MI (US); Jacob David Nelson, Westland, MI (US)

(73) Assignee: Ford Global Technologies, LLC, Dearborn, MI (US)

(21) Appl. No.: 17/097,460

(22) Filed: Nov. 13, 2020

(51) Int. Cl. H04L 9/32; H04L 9/06; H04L 12/40

(52) U.S. Cl. CPC H04L 9/3242; H04L 9/0643; H04L 2209/84; H04L 2012/40273; H04L 12/40104

(57) ABSTRACT

A system comprises a computer including a processor and a memory, the memory including instructions such that the processor is programmed to: receive a data frame including data representing a unified diagnostic services (UDS) request, wherein the data frame includes a hash value and a cipher-based message authentication code (CMAC); calculate an authentication CMAC based on the hash value; compare the CMAC with the authentication CMAC; and transmit control data to a communication module when the CMAC matches the authentication CMAC.

### BACKGROUND

The number and types of electronic devices within vehicles have increased significantly with the digitalization of vehicle parts. Generally, electronic devices may be used throughout the vehicle, such as in a power train control system, a body control system, a chassis control system, a vehicle network, a multimedia system, and so forth. In some instances, diagnostic devices transmit diagnostic requests to the electronic devices for diagnostic purposes.

### BRIEF DESCRIPTION OF THE DRAWINGS

FIG. 1 is a diagram of an example system including a vehicle.

FIG. 2 is a diagram of an example server within the system.

FIG. 3 is a diagram illustrating an example system for authenticating a unified diagnostic services (UDS) request.

FIG. 4 is a diagram of an example data frame including the UDS request, a hash value, and a cipher-based message authentication code (CMAC).

FIG. 5 is a flow diagram illustrating an example process processing a UDS request at a communication module of a vehicle.

FIG. 6 is a flow diagram illustrating an example process for authenticating a UDS request at a vehicle computer.

### DETAILED DESCRIPTION

A system comprises a computer including a processor and a memory, the memory including instructions such that the processor is programmed to: receive a data frame including data representing a unified diagnostic services (UDS) request, wherein the data frame includes a hash value and a cipher-based message authentication code (CMAC); calculate an authentication CMAC based on the hash value; compare the CMAC with the authentication CMAC; and transmit control data to a communication module when the CMAC matches the authentication CMAC.

In other features, the processor is further programmed to: calculate an integrity hash value based on the UDS request; and compare the hash value with the integrity hash value.

In other features, the processor is further programmed to: ignore the UDS request when at least one of the CMAC does not match the authentication CMAC or the hash value does not match the integrity hash value.

In other features, the processor is further programmed to: process the UDS request when the CMAC matches the authentication CMAC and the hash value matches the integrity hash value.

In other features, the processor is further programmed to: transmit diagnostic data based on the UDS request.

In other features, the data frame is received via a vehicle bus.

A system comprising: a communication module comprising a computer including a processor and a memory, the memory including instructions such that the processor is programmed to: calculate a hash value based on a UDS request; calculate a CMAC based on the hash value; encapsulate the UDS request, the hash value, and the CMAC into a data frame; and transmit the data frame to a vehicle computer; the vehicle computer comprising a computer including a processor and a memory, the memory including instructions such that the processor is programmed to: receive the data frame; calculate an authentication CMAC based on the hash value; compare the CMAC with the authentication CMAC; and transmit control data to the communication module when the CMAC matches the authentication CMAC.

In other features, the processor of the vehicle computer is further programmed to: calculate an integrity hash value based on the UDS request; and compare the hash value with the integrity hash value.

In other features, the processor of the vehicle computer is further programmed to: ignore the UDS request when at least one of the CMAC does not match the authentication CMAC or the hash value does not match the integrity hash value.

In other features, the processor of the vehicle computer is further programmed to: process the UDS request when the CMAC matches the authentication CMAC and the hash value matches the integrity hash value.

In other features, the processor of the vehicle computer is further programmed to: transmit diagnostic data based on the UDS request.

In other features, the processor of the communication module is further programmed to: receive a data packet including the UDS request.

In other features, the processor of the communication module is further programmed to: extract the UDS request from the data packet.

In other features, the data frame is transmitted to the vehicle computer via a vehicle bus.

A method comprises: receiving a data frame including data representing a unified diagnostic services (UDS) request, wherein the data frame includes a hash value and a cipher-based message authentication code (CMAC); calculating an authentication CMAC based on the hash value; comparing the CMAC with the authentication CMAC; and transmitting control data to a communication module when the CMAC matches the authentication CMAC.

In other features, the method further comprises: calculating an integrity hash value based on the UDS request; and comparing the hash value with the integrity hash value.

In other features, the method further comprises: ignoring the UDS request when at least one of the CMAC does not match the authentication CMAC or the hash value does not match the integrity hash value.

In other features, the method further comprises: processing the UDS request when the CMAC matches the authentication CMAC and the hash value matches the integrity hash value.

In other features, the method further comprises: transmitting diagnostic data based on the UDS request.

In other features, the method further comprises: receiving the data frame via a vehicle bus.

Diagnostic over Internet Protocol (DoIP) is an automotive diagnostics protocol that facilitates diagnostics related communication between external test equipment and electronic controller units (ECUs) within a vehicle. DoIP enables access to a vehicle's various electronic components, such as the ECUs, through a Ethernet or cellular connection, such that physical access to the vehicle is not required.

DoIP utilizes a Unified Diagnostic Services (UDS) protocol to allow for the transmission of payloads between the external test equipment and the various electronic components of the vehicle. UDS is specified by the International Organization for Standardization as ISO 14229-1. By using the UDS protocol, the payloads can be transmitted between the test equipment and the electronic components over a vehicle's bus, such as a controller area network (CAN). The present disclosure discloses a system and a method for authenticating a UDS request to mitigate unauthorized execution of diagnostic commands and/or extraction of diagnostic information from the vehicle. As discussed in greater detail herein, an ECU can authenticate a UDS request using a single dataframe, which typically provides an increase in vehicle bus efficiency over existing techniques. Thus, ECU authentication of a UDS request using a single dataframe as disclosed herein can provide the advantage of consuming less bandwidth on a vehicle data bus, providing the bandwidth for other vehicle operations and communications and/or allowing for more responsive communications on the vehicle communication bus, for example.

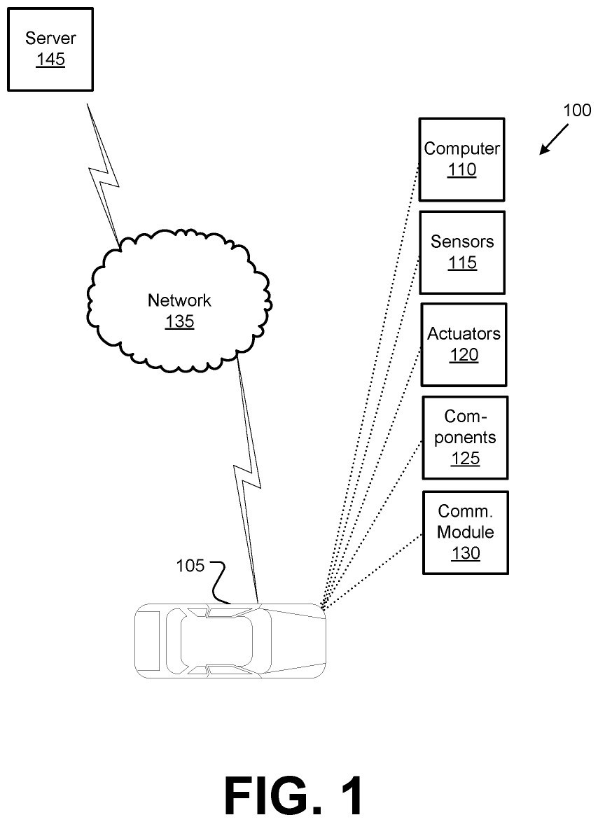

FIG. 1 is a block diagram of an example vehicle system 100. The system 100 includes a vehicle 105, which is a land vehicle such as a car, truck, etc. The vehicle 105 includes a computer 110, vehicle sensors 115, actuators 120 to actuate various vehicle components 125, and a vehicle communications module 130. Via a network 135, the communications module 130 allows the computer 110 to communicate with a server 145.

The computer 110 includes a processor and a memory. The memory includes one or more forms of computer-readable media, and stores instructions executable by the computer 110 for performing various operations, including as disclosed herein.

The computer 110 may operate a vehicle 105 in an autonomous, a semi-autonomous mode, or a non-autonomous (manual) mode. For purposes of this disclosure, an autonomous mode is defined as one in which each of vehicle 105 propulsion, braking, and steering are controlled by the computer 110; in a semi-autonomous mode the computer 110 controls one or two of vehicles 105 propulsion, braking, and steering; in a non-autonomous mode a human operator controls each of vehicle 105 propulsion, braking, and steering.

The computer 110 may include programming to operate one or more of vehicle 105 brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer 110, as opposed to a human operator, is to control such operations. Additionally, the computer 110 may be programmed to determine whether and when a human operator is to control such operations.

The computer 110 may include or be communicatively coupled to, e.g., via the vehicle 105 communications module 130 as described further below, more than one processor, e.g., included in electronic controller units (ECUs) or the like included in the vehicle 105 for monitoring and/or controlling various vehicle components 125, e.g., a powertrain controller, a brake controller, a steering controller, etc. Further, the computer 110 may communicate, via the vehicle 105 communications module 130, with a navigation system that uses the Global Position System (GPS). As an example, the computer 110 may request and receive location data of the vehicle 105. The location data may be in a conventional form, e.g., geo-coordinates (latitudinal and longitudinal coordinates).

The computer 110 is generally arranged for communications on the vehicle 105 communications module 130 and also with a vehicle 105 internal wired and/or wireless network, e.g., a bus or the like in the vehicle 105 such as a controller area network (CAN) or the like, and/or other wired and/or wireless mechanisms.

Via the vehicle 105 communications network, the computer 110 may transmit messages to various devices in the vehicle 105 and/or receive messages from the various devices, e.g., vehicle sensors 115, actuators 120, vehicle components 125, a human machine interface (HMI), etc. Alternatively or additionally, in cases where the computer 110 actually comprises a plurality of devices, the vehicle 105 communications network may be used for communications between devices represented as the computer 110 in this disclosure. Further, as mentioned below, various controllers and/or vehicle sensors 115 may provide data to the computer 110.

Vehicle sensors 115 may include a variety of devices such as are known to provide data to the computer 110. For example, the vehicle sensors 115 may include Light Detection and Ranging (lidar) sensor(s) 115, etc., disposed on a top of the vehicle 105, behind a vehicle 105 front windshield, around the vehicle 105, etc., that provide relative locations, sizes, and shapes of objects and/or conditions surrounding the vehicle 105. As another example, one or more radar sensors 115 fixed to vehicle 105 bumpers may provide data to provide and range velocity of objects (possibly including second vehicles), etc., relative to the location of the vehicle 105. The vehicle sensors 115 may further include camera sensor(s) 115, e.g. front view, side view, rear view, etc., providing images from a field of view inside and/or outside the vehicle 105.

The vehicle 105 actuators 120 are implemented via circuits, chips, motors, or other electronic and or mechanical components that can actuate various vehicle subsystems in accordance with appropriate control signals as is known. The actuators 120 may be used to control components 125, including braking, acceleration, and steering of a vehicle 105.

In the context of the present disclosure, a vehicle component 125 is one or more hardware components adapted to perform a mechanical or electro-mechanical function or operation—such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a brake component (as described below), a park assist component, an adaptive cruise control component, an adaptive steering component, a movable seat, etc.

In addition, the computer 110 may be configured for communicating via a vehicle-to-vehicle communication module or interface 130 with devices outside of the vehicle 105, e.g., through a vehicle-to-vehicle (V2V) or vehicle-to-infrastructure (V2X) wireless communications to another vehicle, to (typically via the network 135) a remote server 145. The module 130 could include one or more mechanisms by which the computer 110 may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the module 130 include cellular, Bluetooth®, IEEE 802.11, dedicated short range communications (DSRC), and/or wide area networks (WAN), including the Internet, providing data communication services.

The network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, Bluetooth Low Energy (BLE), IEEE 802.11, vehicle-to-vehicle (V2V) such as Dedicated Short-Range Communications (DSRC), etc.), local area networks (LAN) and/or wide area networks (WAN), including the Internet, providing data communication services.

A computer 110 can receive and analyze data from sensors 115 substantially continuously, periodically, and/or when instructed by a server 145, etc. Further, object classification or identification techniques can be used, e.g., in a computer 110 based on lidar sensor 115, camera sensor 115, etc., data, to identify a type of object, e.g., vehicle, person, rock, pothole, bicycle, motorcycle, etc., as well as physical features of objects.

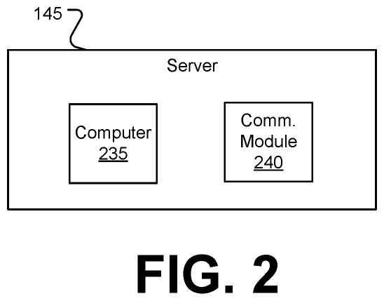

FIG. 2 is a block diagram of an example server 145. The server 145 includes a computer 235 and a communications module 240. The computer 235 includes a processor and a memory. The memory includes one or more forms of computer-readable media, and stores instructions executable by the computer 235 for performing various operations, including as disclosed herein. The communications module 240 allows the computer 235 to communicate with other devices, such as the vehicle 105, e.g., via the network 135 according to conventional wireless and/or wired communication protocols.

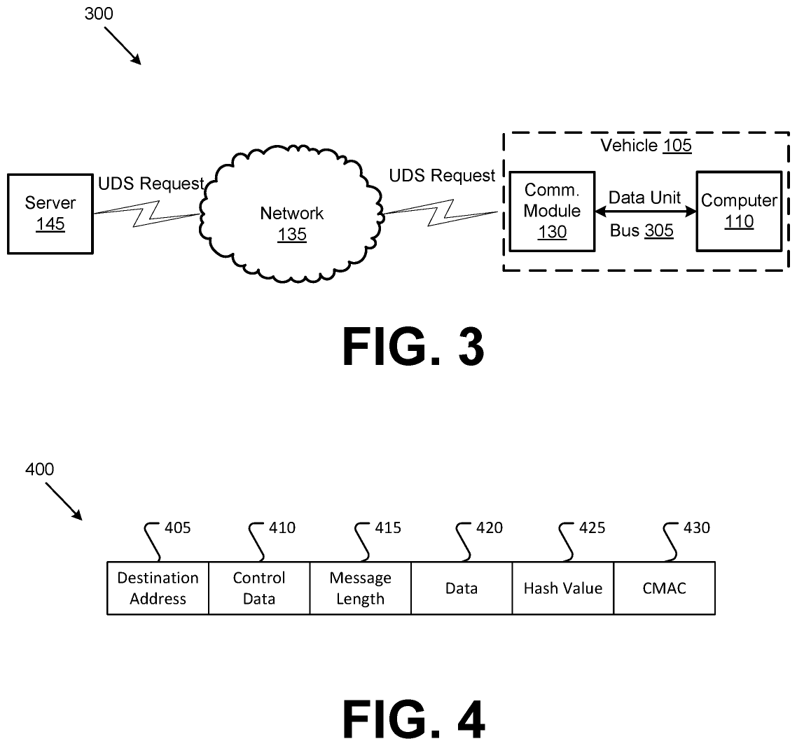

FIG. 3 illustrates an example environment 300 for authenticating Unified Diagnostic Services (UDS) requests transmitted over the communication network 135. In the environment 300 illustrated, the communication network 135 comprises a wireless network. The environment 300 can include the server 145 that communicates with the vehicle 105 via the communication module 130. The communication module 130 includes a processor and a memory. The memory includes one or more forms of computer-readable media, and stores instructions executable by the communication module 130 for performing various operations, including as disclosed herein.

The server 145 can be a diagnostic device that transmits UDS requests to the communication module 130 via the network 135 and can receive diagnostic data from the vehicle 105 based on the UDS requests. The communication module 130 can comprise an in-vehicle gateway that provides scheduling and protocol conversion. For example, the communication module 130 can receive data packets encoded according to a Transmission Control Protocol/Internet Protocol (TCP/IP) and can decapsulate the received data packets and transmit the decapsulated data to the computer 110 via one or more vehicle buses 305, e.g., CAN.

The communication module 130 and/or the server 145 can establish a session to transmit and/or receive data packets between the communication module 130 and/or the server 145. The session can be established upon a determination that diagnostic data is to be transmitted from the computer 110 to the server 145. In an example implementation, the session can be established between the server 145 and the communication module 130 according to a Transport Layer Security (TLS) protocol. In another example implementation, the session can be established between the server 145 and the communication module 130 according to a Service 0×29 Authentication request as specified in the UDS standard.

Once the session is established, the server 145 can encode, i.e., encapsulate, one or more data packets that include a UDS request. The UDS request can comprise a diagnostic message for the computer 110. As discussed above, the vehicle 105 can include multiple computers 110 that comprise ECUs for monitoring the vehicle 105 components 125. In an example implementation, the diagnostic message can include a command to retrieve diagnostic data from the computer 110, which is described in greater detail below. Additionally or alternatively, the computer 110 may causes one or more vehicle 105 components 125 to be actuated based on the UDS request. For example, a vehicle 105 component 125 can be actuated such that diagnostic data can be measured and transmitted in response to the UDS request. After receiving the one or more data packets from the server 145, the communication module 130 can authenticate the one or more data packets as discussed herein. The communication module 130 decapsulates the received data packet(s) and verifies a current quality of service (QoS) threshold with the computer 110, e.g., sending a QoS request to the computer 110. The QoS threshold can be included within the UDS request and can be defined as characteristic of a data link connection between the communication module 130 and the computer 110. If the communication module 130 determines that the QoS threshold of the UDS request is above a QoS threshold of the computer 110, the communication module 130 and the computer 110 can use conventional QoS negotiation techniques to determine a QoS threshold.

The communication module 130 can calculate a hash value for the UDS request. The hash value can be defined as a numeric value of fixed length that uniquely identifies the data of the UDS request. The communication module 130 can use any conventional hash functions that map the data of the UDS request to the fixed length numeric value. Once the communication module 130 calculates the hash value of the UDS request, the communication module 130 calculates one or more message authentication codes (MACs) based on the hash value. In an example implementation, the communication module 130 can use conventional cipher-based message authentication code (CMAC) techniques, which are described, for example, in NIST (The National Institute of Standards and Technology) special publication 800-38B, May 2005.

For example, a secret key is used to encrypt and decrypt the hash value, and the secret key can be stored in the communication module 130 and a copy of the secret key can be stored in the computer 110. The communication module 130 can use the secret key to encrypt the hash value into ciphertext, e.g., encrypted ciphertext, and the computer 110 can use the secret key to decrypt the ciphertext. For example, the communication module 130 uses a CMAC algorithm to generate a CMAC. The communication module 130 can generate the CMAC by inputting the secret key and the hash value into a CMAC algorithm and can append the hash value and the CMAC to the UDS request as discussed below.

FIG. 4 illustrates an example data frame 400 generated by the communication module 130. As shown, the data frame 400 includes a destination address portion 405, a control data portion 410, a message length portion 415, a data portion 420, a hash value portion 425, and a CMAC portion 430. The destination address portion 405 can include a destination address for the data frame 400, e.g., the computer 110, and the control data portion 410 can include control data. The message length portion 415 can include a length, e.g., number of bits, in the data portion 420, and the data portion 420 can include the UDS request. The hash value portion 425 can include the hash value generated by the communication module 130, and the CMAC portion 430 can include the CMAC generated by the communication module 130. The data frame 400 can be transmitted to the computer 110 via the vehicle 105 bus 305 after the data frame 400 is encapsulated by the communication module 130. In some implementations, the communication module 130 transmits the data frame 400 including a first data frame of the UDS request.

The computer 110 can attempt to authenticate the data frame 400 using the copy of the secret key after receiving the data frame 400. In an example implementation, the computer 110 can decapsulate the data frame 400 to obtain the hash value portion 425 and the CMAC portion 430. The computer 110 can generate an authentication CMAC by inputting the copy of the secret key and the hash value into a CMAC algorithm stored on the computer 110. The computer 110 compares the authentication CMAC with the CMAC obtained from the CMC portion 430. The computer 110 can authenticate the data frame 400 when the authentication CMAC matches the CMAC portion 430. The computer 110 can authenticate a UDS request using a single data frame 400, e.g., based on the CMAC included in the data frame 400, which typically results in an increase in bus 305 bandwidth since additional non-authenticated data frames are not transmitted if an initial data frame 400 is not authenticated.

After the data frame 400 is authenticated, the computer 110 transmits the control data from the control data portion 410 to the communication module 130 to indicate the data frame has been authenticated. After receiving the control data, the communication module 130 transmits the remaining data frames including data representing the UDS request to the computer 110. If the data frame 400 is not authenticated, the computer 110 ignores the UDS request.

After the remaining data frames of the UDS request have been received at the computer 110, the computer 110 calculates an integrity hash value for the UDS request and compares the integrity hash value to the hash value from the hash value portion 425. The computer 110 can use the hash value function used by the communication module 130 to calculate the integrity hash value. If the integrity hash value matches the hash value, the computer 110 transmits an acknowledgement to the communication module 130 and performs actions requested in the UDS request. If the integrity hash value does not match the hash value, the computer 110 ignores the UDS request.

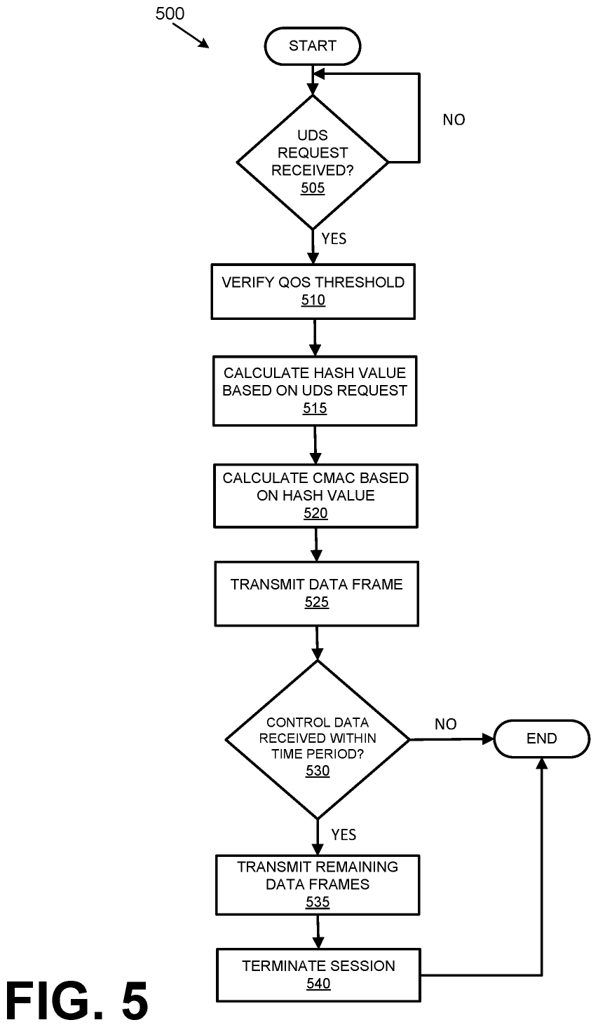

FIG. 5 illustrates an example process 500 for processing a UDS request. Blocks of the process 500 can be executed by a processor of the communication module 130. The process 500 begins at block 505 in which a determination is made whether data, e.g., a UDS request, has been received from the server 145. The communication module 130 can monitor whether a UDS request has been received from the server 145 via the communication network 135. The UDS request can comprise a TCP/IP data packet. If a UDS request has not been received, the process 500 returns to block 505. If a UDS request has been received from the server 145, the communication module 130 extracts the UDS request and verifies the QoS threshold with a destination computer 110 at block 510. In some implementations, the communication module 130 and the computer 110 can use conventional QoS negotiation techniques to determine a QoS threshold if the QoS threshold of the UDS request is above a QoS threshold of the computer 110.

At block 515, the communication module 130 calculates a hash value for the UDS request, e.g., payload. At block 520, the communication module 130 calculates a CMAC based on the hash value. At block 525, the communication module 130 transmits a data frame, such as data frame 400, to the destination computer 110. As discussed above, the communication module 130 generates and transmits a data unit 400 that includes data representing the UDS request, the hash value, and the CMAC.

At block 530, the communication module 130 determines whether control data has been received within a predefined time period. The predefined time period can be defined as a timeout period set by the vehicle 105 manufacturer. If control data is not received within the predefined time period, the process 500 ends. If control data has been received within the predefined time period, the communication module 130 transmits one or more data frames, e.g., the remaining data frames including the UDS request, to the computer 110 at block 535. The one or more data frames can include data representing the UDS request. In an example implementation, the one or more data frames transmitted at block 535 do not include data representing the CMAC. At block 540, the communication module 130 terminates a session after an acknowledgement is received. The process 500 then ends.

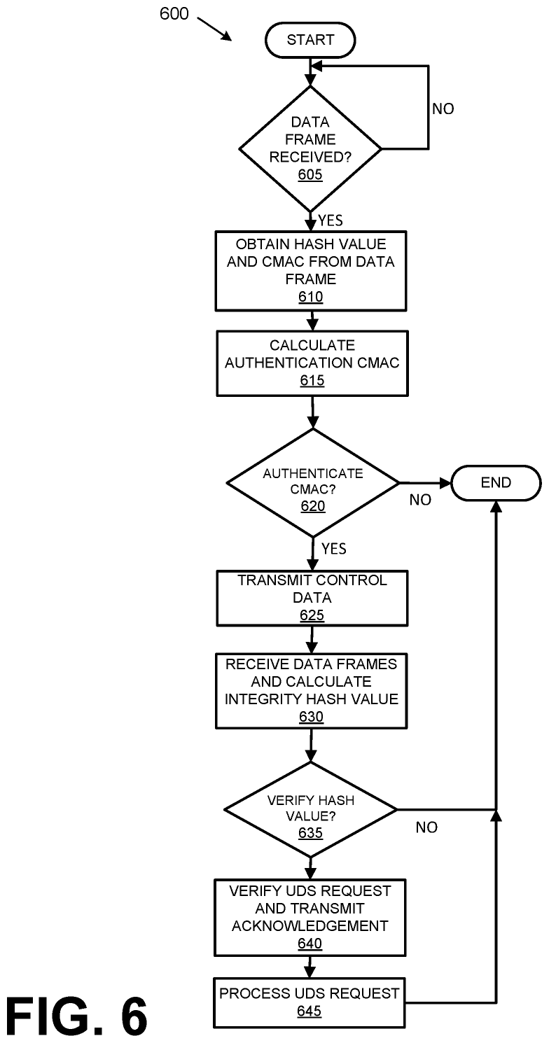

FIG. 6 illustrates an example process 600 for authenticating a UDS request. Blocks of the process 600 can be executed by a processor of the computer 110. The process 600 begins at block 605 in which a determination is made whether a data frame, such as a data frame 400 has been received from the communication module 130. If the data frame has not been received, the process 600 returns to block 605. If the data frame has been received, the computer 110 decapsulates the data frame to obtain the hash value and the CMAC at block 610.

At block 615, the computer 110 calculates an authentication CMAC using the hash value, as described in greater detail above. At block 620, the computer 110 determines whether the authentication CMAC matches the CMAC obtained from the data frame. If the authentication CMAC does not match the CMAC, the computer 110 ignores the data frame, and the process 600 ends. If the CMAC matches the CMAC, the computer 110 transmits control data the communication module 130 at block 625. At block 630, the computer 110 receives the remaining data frames and calculates an integrity hash value using the data from each of the data frames representing the UDS request.

At block 635, the computer 110 determines whether the integrity hash value matches the hash value obtained from the data frame. If the integrity hash value does not match the hash value, the computer 110 ignores the UDS request, and the process 600 ends. If the verification hash value matches the hash value, the computer 110 verifies the UDS request and transmits an acknowledgement to the communication module 130 at block 640. At block 645, the computer 110 processes the UDS request. In an example implementation, the computer 110 may cause one or more vehicle 105 components 125 to be actuated based on the UDS request such that diagnostic data can be measured and transmitted in response to the UDS request. For example, the computer 110 can transmit diagnostic data according to the UDS request. The process 600 then ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system comprising a computer including a processor and a memory, the memory including instructions such that the processor is programmed to:
receive a data frame including data representing a unified diagnostic services (UDS) request, wherein the data frame includes a hash value and a cipher-based message authentication code (CMAC);
calculate an authentication CMAC based on the hash value;
compare the CMAC with the authentication CMAC; and
transmit control data to a communication module when the CMAC matches the authentication CMAC.

2. The system of claim 1, wherein the processor is further programmed to:
calculate an integrity hash value based on the UDS request; and
compare the hash value with the integrity hash value.

3. The system of claim 2, wherein the processor is further programmed to:
ignore the UDS request when at least one of the CMAC does not match the authentication CMAC or the hash value does not match the integrity hash value.

4. The system of claim 2, wherein the processor is further programmed to:
process the UDS request when the CMAC matches the authentication CMAC and the hash value matches the integrity hash value.

5. The system of claim 4, wherein the processor is further programmed to: transmit diagnostic data based on the UDS request.

6. The system of claim 1, wherein the data frame is received via a vehicle bus.

7. A system comprising:
a communication module comprising a computer including a processor and a memory, the memory including instructions such that the processor is programmed to:
calculate a hash value based on a UDS request;
calculate a CMAC based on the hash value;
encapsulate the UDS request, the hash value, and the CMAC into a data frame; and
transmit the data frame to a vehicle computer;
the vehicle computer comprising a computer including a processor and a memory, the memory including instructions such that the processor is programmed to:
receive the data frame;
calculate an authentication CMAC based on the hash value;
compare the CMAC with the authentication CMAC; and
transmit control data to the communication module when the CMAC matches the authentication CMAC.

8. The system of claim 7, wherein the processor of the vehicle computer is further programmed to:
calculate an integrity hash value based on the UDS request; and
compare the hash value with the integrity hash value.

9. The system of claim 8, wherein the processor of the vehicle computer is further programmed to:
ignore the UDS request when at least one of the CMAC does not match the authentication CMAC or the hash value does not match the integrity hash value.

10. The system of claim 8, wherein the processor of the vehicle computer is further programmed to:
process the UDS request when the CMAC matches the authentication CMAC and the hash value matches the integrity hash value.

11. The system of claim 10, wherein the processor of the vehicle computer is further programmed to: transmit diagnostic data based on the UDS request.

12. The system of claim 7, wherein the processor of the communication module is further programmed to: receive a data packet including the UDS request.

13. The system of claim 12, wherein the processor of the communication module is further programmed to: extract the UDS request from the data packet.

14. The system of claim 7, wherein the data frame is transmitted to the vehicle computer via a vehicle bus.

15. A method comprising:
receiving a data frame including data representing a unified diagnostic services (UDS) request, wherein the data frame includes a hash value and a cipher-based message authentication code (CMAC);
calculating an authentication CMAC based on the hash value;
comparing the CMAC with the authentication CMAC; and
transmitting control data to a communication module when the CMAC matches the authentication CMAC.

16. The method of claim 15, further comprising:
calculating an integrity hash value based on the UDS request; and
comparing the hash value with the integrity hash value.

17. The method of claim 16, further comprising:
ignoring the UDS request when at least one of the CMAC does not match the authentication CMAC or the hash value does not match the integrity hash value.

18. The method of claim 16, further comprising:
processing the UDS request when the CMAC matches the authentication CMAC and the hash value matches the integrity hash value.

19. The method of claim 15, further comprising: transmitting diagnostic data based on the UDS request.

20. The method of claim 15, further comprising: receiving the data frame via a vehicle bus.
